(19) United States
(12) Patent Application Publication
(10) Pub. No.: US 2007/0279323 A1
(43) Pub. Date: Dec. 6, 2007

(54) METHOD OF COMPENSATING FOR CHANNEL INTERFERENCE OF DISPLAY APPARATUS AND DEVICE FOR CONTROLLING DRIVING OF DATA SIGNAL

(75) Inventors: Jin Park, Seongnam-si (KR); Joon-Seok Lee, Seoul (KR); Dae Young Jung, Seoul (KR)

Correspondence Address: DITTHAVONG MORI & STEINER, P.C., 918 Prince St., Alexandria, VA, 22314, US

(73) Assignee: HANA MICRON CO., LTD., Asan-si (KR)

(21) Appl. No.: 11/697,160

(22) Filed: Apr. 5, 2007

(30) Foreign Application Priority Data
Apr. 26, 2006 (KR) 10-2006-0037666

(51) Int. Cl. G09G 3/20

(52) U.S. Cl. 345/55; 345/204

(57) ABSTRACT

A method of compensating for channel interference of a display apparatus and a device for controlling driving of a data signal are provided. The method of compensating for the channel interference of the display apparatus includes: receiving pixel data of a scan line selected from an external screen memory; summing up the received pixel data and detecting a compensation time for compensating for channel interference which occurs in the selected scan line by using the sum of the pixel data; and adjusting at least one of a discharge time and a peak boost time of a driving current that is output to each data line according to the detected compensation time. Accordingly, it is possible to solve problems such as an increase of the circuit size caused by the existing compensation for the channel interference by controlling the discharge period or peak boost period with respect to each scan line and compensating for the channel interference phenomenon.

### BACKGROUND

1. Technical Field

The present invention relates to a method of compensating for channel interference of a display apparatus and a method of controlling driving of a data signal, and more particularly, to a method of compensating for channel interference of a display apparatus in which a channel interference phenomenon that occurs when a display panel is driven by controlling a time length of a discharge period or peak boost period for each scan line and a device for controlling driving of a data signal related thereto.

2. Related Art

Recently, a light emitting device using an emissive element and a light emitting display apparatus employing the light emitting device as a pixel have been actively developed. At this time, the emissive element may have various shapes by using various materials such as an organic material, a non-organic material, a thin film material, a bulk material, a distributed material, and the like.

One of the typical emissive elements is an organic light emitting diode (hereinafter, abbreviated to OLED) element. An OLED display apparatus employing the OLED element as a light emitting pixel can more slim down and can be more light-weighted than an existing liquid crystal display. In addition, the OLED display apparatus has characteristics such as a high response speed suitable for a moving picture display, a wide viewing angle, a low voltage driving. Thus, the OLED display apparatus has been spotlighted as the next generation display apparatus which can be applied to a mobile phone, a personal digital assistant (PDA), a television set, a monitor, and the like.

FIG. 1 is a circuit diagram illustrating a basic structure of a general passive matrix (PM) OLED display apparatus. FIG. 1 shows a structure of an OLED display panel and a driving circuit thereof.

Referring to FIG. 1, in an OLED display panel 10, a plurality of scan lines S1 to Sm cross a plurality of data lines D1 to Dn in a matrix shape. An OLED element (hereinafter, referred to as pixel) P is disposed at each crossing point of the scan lines S1 to Sm and the data lines D1 to Dn. An anode of each pixel P is connected to the corresponding data line D1 to Dn, and a cathode of each pixel P is connected to the corresponding scan line S1 to Sm. Here, each pixel P can be equivalently represented as a circuit obtained by connecting a light emitting diode to a parasitic capacitor in parallel.

A scan driving unit 30 sequentially drives m number of scan lines S1 to Sm in response to an externally applied an m-bit scan signal. The scan driving unit 30 includes m number of scan driving circuits SC1 to SCm respectively connected to the scan lines S1 to Sm. Each scan driving circuit SC1 to SCm switches the corresponding scan line to a power source 16 or a ground 12 in response to a scan signal of the bit corresponding to the scan driving circuit SC1 to SCm.

In addition, a data driving unit 20 outputs data to the n number of data lines D1 to Dn in response to externally applied n number of data signals. The data driving unit 20 includes n number of data driving circuits DC1 to DCn respectively connected to the data lines D1 to Dn. Each data driving circuit DC1 to DCn supplies a driving current to the corresponding data lines D1 to Dn in response to a data signal of the bit corresponding to the data driving circuit DC1 to DCn.

At this time, a pixel driving current flows into only one pixel which is connected to the scan driving circuit SC1 to SCm connected to the ground 12 among the pixels P connected to the data driving circuits DC1 to DCn. Accordingly the pixel P emits light. On the other hand, since the driving current does not flow through the pixels P which are connected to scan driving circuits SC1 to SCm connected to the power source 16, the pixels P do not emit light.

Accordingly, in the OLED display panel 10, pixels P emit light in units of scan lines S2 connected to the ground 12, that is, enabled scan lines, and a frame is displayed by allowing the scan lines S1 to Sm to be sequentially enabled.

At this time, the luminance of the pixel P is proportional to the total amount of currents flowing through the pixel P. This relation is represented by Equation 1 as follows:

Bp∝Id×It, [Equation 1]

where Bp is the luminance of a pixel, Id is a current supplied by the data driving unit, and It is a driving time.

On the other hand, in the OLED display apparatus, since each pixel has a parasitic capacitance, even when the driving current is supplied, the driving current cannot rapidly reach a sufficient signal level within a predetermined driving time. Accordingly, a technique in which pixels rapidly reach the desired luminance by supplying a driving current with a boosted level to the pixels for a predetermined time is disclosed in Japanese Unexamined Patent Application Publication No. 1999-231834, Korean Patent No. 437477, and the like.

FIG. 2 is a block diagram illustrating the OLED display apparatus according to the disclosed existing technique. FIG. 2 illustrates a structure of a data driving circuit 40 and operating mechanism thereof.

Referring to FIG. 2, the data driving circuit 40 includes a data register 41 for storing pixel data and a data signal driving circuit 42 for outputting a driving current.

The data signal driving circuit 42 includes a discharge driving circuit 43, a peak boost driving circuit 45, and a data period driving circuit 47. At this time, one of the discharge driving circuit 43, the peak boost driving circuit 45, and the data period driving circuit 47 may be connected to a data line S by a switch 46 that is controlled by a data control logic 50.

FIG. 3 is a graph illustrating variation of a driving current output from the data period driving circuit 47. FIG. 3 illustrates an output signal of the data driving circuit 40 that varies during a scan line active period. Here, a scan line active period indicates a unit time for which the scan line is activated so as to allow the pixel to emit light.

Referring to FIG. 3, since the scan driving circuit SC during the scan line active period is connected to the ground 12, the voltage of the scan driving circuit SC is at a low level. The scan line active period is largely divided into three periods depending on an operating state of the data driving circuit 40. Specifically, the three periods are a discharge period (free-charge period), a peak boost period, and a data period.

In the discharge period, an electric charge that is previously charged in the scan line D to be driven is discharged so that the scan line D is at a reference level. In the peak boost period, a current that is one to ten times of a current corresponding to the data value is supplied so that the pixel P emits light in a luminance close to a luminance corresponding to the data value in a short time. In addition, in the data period, a current is supplied to the pixel P so that the pixel emits light in a luminance corresponding to the given data value.

The discharge period, the peak boost period, and the data period can be performed by sequentially selecting the discharge driving circuit 43, the peak boost driving circuit 45, and the data period driving circuit 47 through the switch 46 controlled by the data control logic 50. At this time, the discharge driving circuit 43 can be embodied through a zener diode. The peak boost driving circuit 45 and the data period driving circuit 47 may be constructed with a voltage or current source with a suitable current scope.

On the other hand, when a PM OLED display is practically driven, currents of all the channels flow through a single scan line via corresponding pixels. At this time, a voltage drop due to on-resistance of a scan and connecting wire resistance occurs, and the voltage drop is proportional to the total sum of the currents of all the channels. That is, when the display apparatus is practically driven, as the total sum of the current increases, the voltage drop increases. Accordingly, the current flows through the pixel as much as when there is no voltage drop by allowing more current corresponding to the voltage drop to flow through the pixel. The phenomenon, in which a luminance of each pixel varies depending on the total amount of the currents of the channels, is a channel crosstalk or channel interference (hereinafter, referred to as channel interference) phenomenon.

In order to minimize the channel interference phenomenon, there have been used several methods in the past.

First, there is a method of minimizing on-resistance of a switching transistor of the scan driving circuit.

Specifically, a reduction of the driving current due to resistance caused by the interference phenomenon is minimized by reducing the on resistance of a switching transistor of the scan driving circuit to the highest degree. In order to perform the aforementioned method, the size of the switch transistor of the scan driving circuit has to be large, and accordingly, the size of the driving IC increases. The interference phenomenon caused by connection wires on the panel cannot be compensated for.

Second, a voltage drop caused by connection wires is compensated for by using adjusting a discharge level. Specifically, a voltage to be additionally raised is previously increased by increasing the discharge level. In order to perform the second method, an operational amplifier (hereinafter, abbreviated to OP-AMP) for generating a minute level voltage has to be embodied. However, in order to embody the aforementioned OP-AMP, an offset voltage has to be designed to be extremely minute. Accordingly, an additional area is needed for the OP-AMP. Therefore, a size and power consumption of the driving IC increase.

### SUMMARY

The present invention provides a method of compensating for channel interference of a display apparatus capable of effectively compensating for a luminance change caused by the channel interference phenomenon which may occur when a display panel is driven.

The present invention also provides a device for controlling driving of a data signal of a display apparatus capable of performing a stable display operation by compensating for a luminance change of a pixel caused by a channel interference phenomenon which may occur when a display panel is driven.

According to an aspect of the present invention, there is provided a method of compensating for channel interference of a display apparatus, the method comprising: receiving pixel data of a scan line selected from an external screen memory; summing up the received pixel data and detecting a compensation time for compensating for channel interference which occurs in the selected scan line by using the sum of the pixel data; and adjusting at least one of a discharge time and a peak boost time of a driving current that is output to each data line according to the detected compensation time. In the detecting of the compensation time, the compensation time may be detected by searching a lookup table in which a compensation time depending on the sum of the pixel data of the scan line is stored by using the sum of the pixel data.

According to another aspect of the present invention, there is provided a method of compensating for channel interference of a display apparatus, the method comprising: receiving pixel data of a scan line selected from an external screen memory; summing up the received pixel data; calculating a compensation energy which compensates for a loss caused by channel interference that occurs in the selected scan line by using the sum of the pixel data; detecting the compensation time corresponding to the calculated compensation energy; and adjusting at least one of a discharge time and a peak boost time of a driving current that is output to each data line according to the detected compensation time.

In the above aspect of the present invention, the calculating of the compensation time may comprise: detecting an ideal energy value, which drives the pixels connected to the selected scan line in luminance corresponding to the sum of the pixel data, and a practically measured energy value, which drives the pixels connected to the selected scan line in the luminance corresponding to the sum of the pixel data; and subtracting the detected measured energy value from the detected ideal energy value.

According to another aspect of the present invention, there is provided a device for controlling driving of a data signal, which controls a driving current supplied to a data line of a display panel, the device comprising: a data summation unit which receives pixel data to be displayed on a selected scan line of the display panel and sums up the pixel data; a lookup table in which compensation time information corresponding to the sum of the pixel data of the scan line of the display panel is stored; and a data control logic unit which detects a compensation time corresponding to the sum obtained from the data summation unit by searching the lookup table and adjusts at least one of the discharge period and the peak boost period of the driving current supplied to the data line on the basis of the detected compensation time.

According to another aspect of the present invention, there is provided a device for controlling driving of a data signal, which controls a driving current supplied to a data line of a display panel, the device comprising: a data summation unit which receives pixel data to be displayed on a selected scan line of the display panel and sums up the pixel data; a compensation time providing unit which provides compensation time information corresponding to the sum of the pixel data of the scan line of the display panel; and a control logic unit which receives a compensation time corresponding to the sum obtained from the data summation unit from the compensation time providing unit and adjusts at least one of the discharge period and the peak boost period of the driving current supplied to the data line on the basis of the detected compensation time.

The compensation time providing unit may calculate a compensation energy capable of compensating for a loss caused by channel interference which occurs in the scan line and provide the compensation time corresponding to the calculated compensation energy.

### BRIEF DESCRIPTION OF THE DRAWINGS

The above and other features and advantages of the present invention will become more apparent by describing in detail exemplary embodiments thereof with reference to the attached drawings in which:

FIG. 1 is a circuit diagram illustrating a basic structure of a general passive matrix (PM) OLED display apparatus;

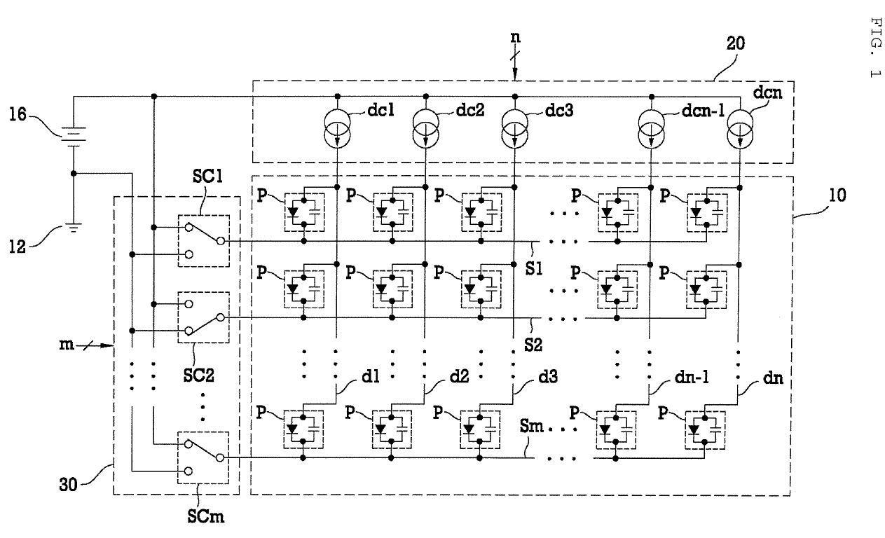

FIG. 2 is a circuit diagram illustrating the OLED display apparatus according to the disclosed existing technique;

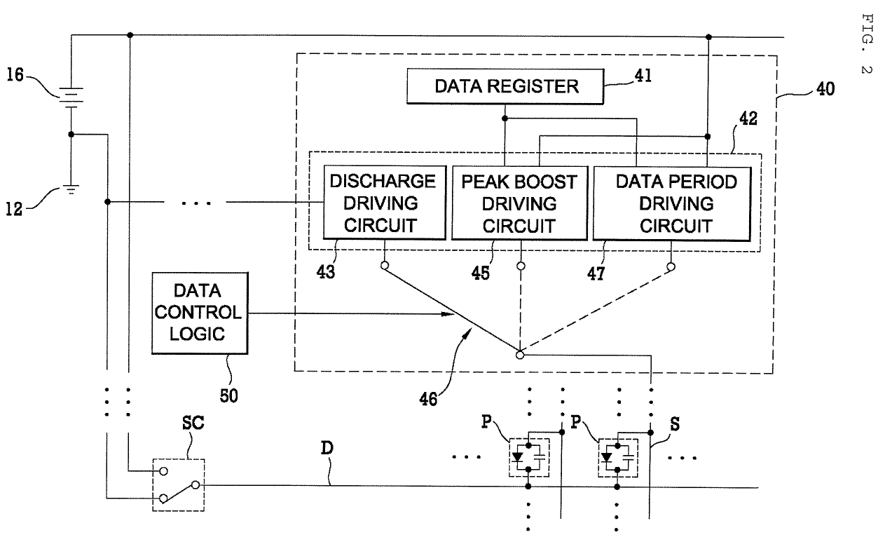

FIG. 3 is a graph illustrating variation of a driving current that is output from a data period driving circuit;

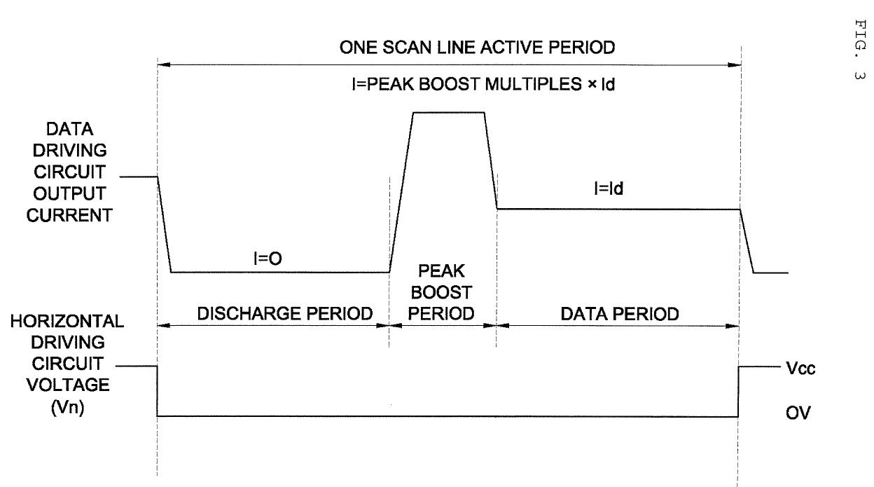

FIG. 4 is a circuit diagram illustrating a display apparatus including a device for controlling driving of a data signal according to an exemplary embodiment of the present invention;

FIG. 5 is a circuit diagram illustrating a data signal period control device according to an exemplary embodiment of the present invention;

FIG. 6 is a flowchart illustrating an operation of the data signal period control device shown in FIG. 5;

FIG. 7 illustrates an example in which a discharge time to which a compensation time is applied is stored in a format of a lookup table; and

FIG. 8 illustrates an example in which a peak boost time to which a compensation time is applied is stored in a format of a lookup table.

### DESCRIPTION OF EXEMPLARY EMBODIMENTS

Now, preferred embodiments of the present invention will be described in detail with reference to the attached drawings. In addition, in order to clearly describe exemplary embodiments with reference to the accompanying drawings, specific technical terms are used. However, the present invention is not limited to the selected specific technical terms, and each specific technical term includes all the technical synonyms which operate in a similar manner so as to achieve a similar object.

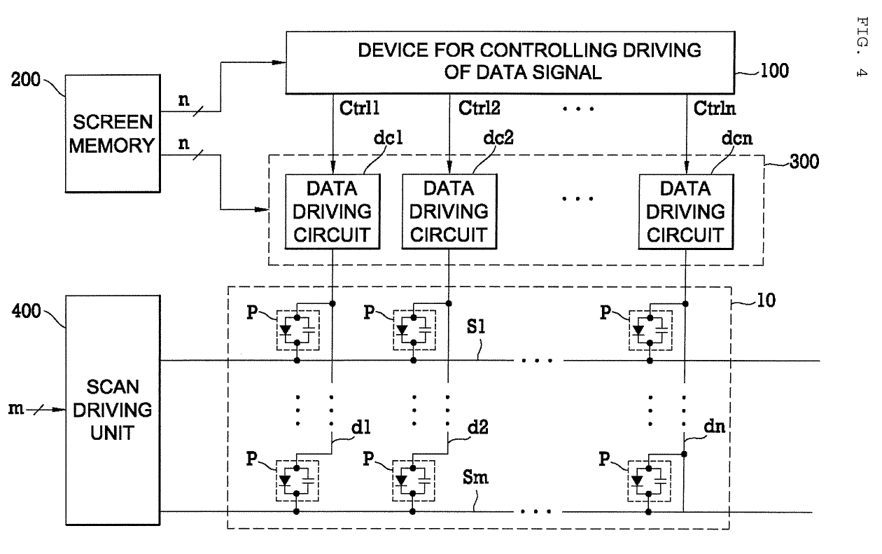

FIG. 4 is a circuit diagram illustrating a display apparatus including a device for controlling driving of a data signal according to an exemplary embodiment of the present invention. FIG. 4 illustrates a passive matrix OLED display apparatus which includes the device for controlling driving of a data signal.

As shown in FIG. 4, the OLED display apparatus may include a screen memory 200. In the screen memory 200, pixel data according to a frame screen to be displayed is stored for each scan line S1 to Sm. For example, since pixel data of a frame screen has a one-to-one correspondence with a pixel P of the display panel, m×n pixel data can be stored in the screen memory for each scan line S1 to Sm. At this time, the scan line S1 to Sm may includes n number of pixel data.

On the other hand, the stored pixel data for each scan line S1 to Sm can be supplied to the device 100 for controlling driving of the data signal depending on a sequential selection of the scan lines S1 to Sm.

A scan driving unit 400 sequentially drives the m number of scan lines S1 to Sm from the first scan line to the m-th scan line in response to the m-bit scan signal. That is, the selected scan line S1 to Sm is activated one by one.

The device 100 for controlling driving of the data signal sequentially receives the pixel data stored in the screen memory 200 for each scan line S1 to Sm in synchronization with the selection of the scan lines S1 to Sm and applies the n-bit data control signals Ctrl1 to Ctrln. That is, the n number of data signal driving circuits DC1 to DCn in the data driving unit 300 are controlled.

At this time, the data control signals Ctrl1 to Ctrln can serve to control the discharge period, the peak boost period, and the data period of the driving current supplied to the corresponding data line D1 to Dn by the data signal driving circuit DC1 to DCn. Accordingly, the driving current with a predetermined sequence can be supplied to the n number of data lines D1 to Dn under the control of the data control signal Ctrl1 to Ctrln. The pixels P, which are connected to the scan lines activated by the driving current, emit light.

On the other hand, the device 100 for controlling driving of the data signal receives the n number of pixel data for each sequentially selected scan line S1 to Sm, detects a compensation time for compensating for the channel interference which may occurs in the corresponding scan line S1 to Sm by using energy information of the received pixel data, and adjust the discharge time or peak boost time of the driving current supplied to the pixels of the selected scan line S1 to Sm in consideration of the detected compensation time.

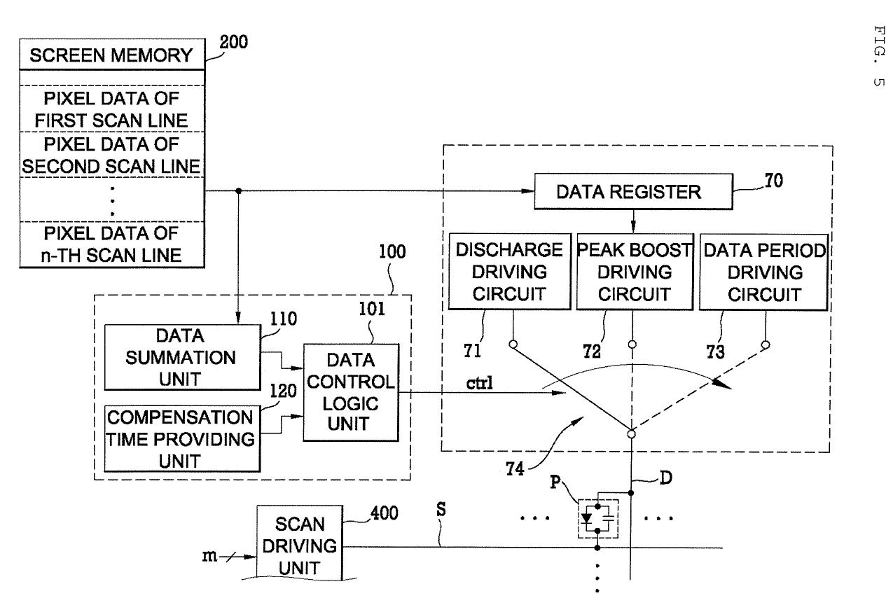

FIG. 5 is a circuit diagram illustrating a device for controlling driving of a data signal 100 according to an exemplary embodiment of the present invention. FIG. 5 shows an example in which a data control signal is applied to one data signal driving circuit among the plurality of data signal driving circuits DC1 to DCn shown in FIG. 4.

As shown in FIG. 5, the device 100 for controlling driving a data signal includes a data summation unit 110, a compensation time providing unit 120, and a data control logic unit 101.

The data summation unit 110 receives the pixel data to be displayed on the selected scan line S from the screen memory 200 and sums up the pixel data. At this time, the summation of the pixel data may denote summation of gray level values of the pixels P to be displayed on the scan line S. Accordingly, when the sum of the pixel data is calculated, the total energy information needed for driving the pixels that are practically connected to the corresponding scan line S can be obtained.

The compensation time providing unit 120 serves to provide a compensation time for compensating for the channel interference that occurs in the selected scan line S on the basis of the sum of the pixel data of the scan line S. The compensation time providing unit 120 may be embodied as a lookup table (LUP) or logic. The compensation time providing unit may use an operation circuit basically included in a driving IC or a part of a memory.

The data control logic unit 101 basically includes a function of applying a data control signal ctrl1 to the data signal driving circuit DC. At this time, the data control signal ctrl1 serves to sequentially select a discharge driving circuit 71, a peak boost driving circuit 72, and a data period driving circuit 73 of the data driving circuit DC. That is, the data control signal ctrl can controls the selection switch 74.

At this time, the data control logic unit 101 can adjust the selection time of the discharge driving circuit 71 or peak boost driving circuit 72 on the basis of the compensation time for each scan line. That is, the data control logic unit 101 detects a compensation time corresponding to the sum obtained from the data summation unit 110 from the compensation time providing unit 120 and adjusts the discharge time or peak boost time of the driving current depending on the corresponding compensation time.

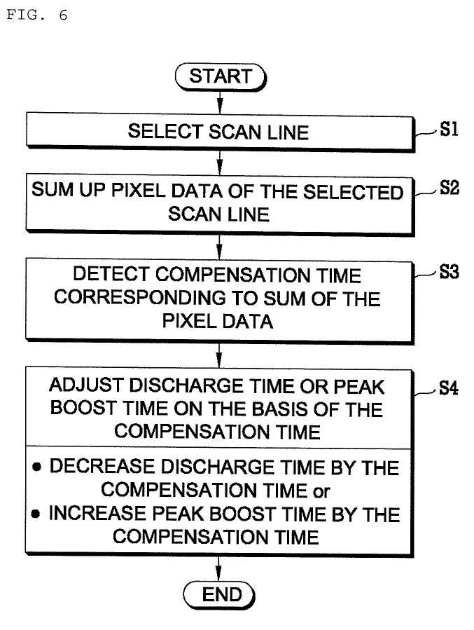

FIG. 6 is a flowchart illustrating an operation of the device for controlling driving of the data signal shown in FIG. 5. FIG. 6 illustrates a method of compensating for channel interference according to an exemplary embodiment of the present invention. In addition, functions of the aforementioned components will be more apparent through the flowing description on the flowchart.

Referring to FIGS. 5 and 6, when a scan line S is selected (operation S1), the pixel data of the corresponding scan line S is stored in a data register 70 of the data driving circuit DC and supplied to the summation unit 110, at the same time.

When the pixel data is transmitted from the screen memory 200 to the data summation unit 110, the data summation unit 110 sums up the pixel data (operation S2). For example, it is assumed that a size of the screen which is a size of the display panel is 8×8 (n=8 and m=8) and a pixel can have 2-bit data that are gray levels of 0 to 3. When the pixel data of the selected scan line is 0, 1, 2, 3, 3, and 0, the sum of the pixel data obtained from the data summation unit 110 is 12.

Subsequently, the data control logic unit 101 receives the sum of the pixel data from the data summation unit 110 and detects a compensation time corresponding to the sum of the pixel data from the compensation time providing unit 120 (operation S3). At this time, the compensation time may be calculated by an operation of the compensation time providing unit 120 or provided in a lookup table format. Preferably, the lookup table format will be more advantageous in rapidity of data processing and simplicity of logic.

In order to calculate the compensation time, a compensation energy for compensating for channel interference that occurs in a predetermined scan line has to be calculated. At this time, the compensation energy may be obtained by subtracting an energy practically measured when the pixels connected to the scan line in the aforementioned luminance from a theoretical energy value needed for allowing the pixels connected to a predetermined single scan line to emit light in a predetermined luminance.

The aforementioned relation is represented Equation 2 as follows:

Cenergy(K)=Tenergy(K)−Eenergy(K)+α(K), [Equation 2]

where Tenergy(K) is a theoretical total energy needed for allowing pixels connected to a scan line to emit light in a desired gray level of K, Eenergy(K) is a practically measured total energy needed for allowing pixels connected to the scan line in a gray level K, Cenergy(K) is a compensation energy, and α(K) is a variable for compensating for a non-linear characteristic of the luminance of the display panel. α(K) may be suitably set depending on a characteristic of the display panel, a practically measured total energy, and driving performance of a driving IC. α(K) has a range of 0≦α(K)≦Tenergy(K)−Tenergy(K−1).

As known from Equation 2, theoretical total energy is different from practically measured total energy. This is because energy loss due to the channel interference may occur in the scan line. This energy loss can be represented as a compensation energy Cenergy(K). Accordingly, the compensation energy of the pixels of the scan line is previously stored in correspondence with the luminance value.

For example, when it is assumed that the size of the screen is 8×8 (n=8 and m=8), each pixel has gray levels of 0, 1, 2, and 3, and a predetermined compensation variable α(K) is 0, the sum of the gray levels of the 8 pixels of a scan line may range from 0 to 24 (=3×8). That is, a gray level K ranges from 0 to 24.

At this time, for convenience, when it is assumed that Energy(K)=K, the compensation energy may be set as in the following.

1. 0:0≦Eenergy(K)<11

2. 0.25:12≦Eenergy(K)<16

3. 0.5:17≦Eenergy(K)<20

4. 0.75:21≦Eenergy(K)<24

Here, when the sum of the pixel data obtained from the data summation unit 110 is 12, the compensation energy is 0.25.

The obtained compensation energy can be compensated for by increasing a supply of the driving current by reducing the discharge time by a predetermined compensation time needed for compensating for the compensation energy (operation S4). That is, the discharge time for which the discharge driving circuit 71 of the data driving circuit DC operates corresponds to a time obtained by subtracting an absolute value of the compensation time from a reference discharge time. The aforementioned relation is represented by Equation 3 as follows:

Sctrl_disc=Fn(Tdisc_{—}R−Tdisc_{—}C), [Equation 3]

where Tdisc_R is a reference discharge time, Tdisc_C is a compensation time (an absolute value), and Sctrl-disc is an adjusted discharge time.

As shown in Equation 3, the adjusted discharge time Sctrl_disc can be calculated by a function obtained by subtracting the compensation time Tdisc_C from the reference discharge time Tdisc_R. Accordingly, the compensation time needed for compensating for the compensation energy of 0.25 is 1 time unit. When the reference discharge time is 10 time units, the practical discharge time is 9 time units in consideration of the compensation time.

In the aforementioned process (operation S4), when the control logic unit 101 requests the compensation time providing unit 120 to provide the compensation time depending on the sum of the pixel data of the scan line S, the compensation time providing unit 120 may calculate and provide the compensation time on the basis of Equations 2 and 3. Alternatively, the compensation time providing unit 120 may store the compensation time depending on the total energy value of the scan line S in a lookup table format and provide the compensation time in response to the request of the data control logic unit 101.

On the other hand, the compensation energy can be compensated for by increasing a supply of the driving current by increasing the peak boost time by a predetermined compensation time (operation S4). In this case, the peak boost time that is a period for which the peak boost driving circuit 72 of the data driving circuit DC operates corresponds to a time obtained by adding the absolute value of the compensation time to the reference peak boost time. The aforementioned relation is represented by Equation 4 as follows:

Sctrl_peak=Fn(Tpeak_{—}R−Tpeak_{—}C), [Equation 4]

where Tpeak_R is a reference peak boost time, Tpeak_C is a compensation time (absolute value), and Sctrl_peak is an adjusted peak boost value.

As shown in Equation 4, the adjusted peak boost time Sctrl_peak can be calculated by a function obtained by subtracting the compensation time Tpeak_C from the reference peak boost time Tpeak_R. Accordingly, the compensation time for compensating for the compensation energy of 0.25 is 1 time unit. When the reference discharge time is 10 time units, the practical discharge time is 11 time units in consideration of the compensation time.

Similarly, in the aforementioned process (operation S4), when the control logic unit 101 requests the compensation time providing unit 120 to provide the compensation time depending on the sum of the pixel data of the scan line S, the compensation time providing unit 120 may calculate and provide the compensation time on the basis of Equations 2 and 4. Alternatively, the compensation time providing unit 120 may store the compensation time depending on the total energy value of the scan line S in a lookup table format and provide the compensation time in response to the request of the data control logic unit 101.

On the other hand, in order to further reduce the operation amount, the compensation time providing unit 120 may provide the discharge time or peak boost time, to which the compensation time is applied, in a lookup table format directly to the data control logic unit 101.

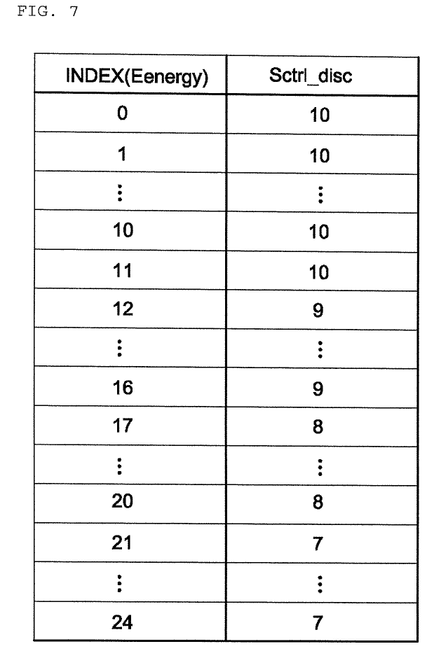

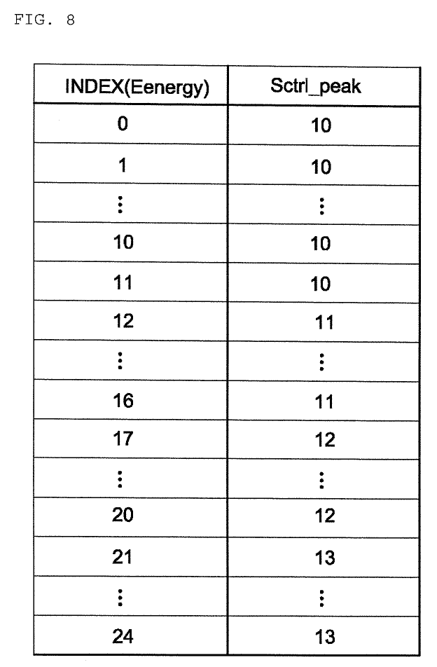

FIG. 7 illustrates an example in which a discharge time to which a compensation time is applied is stored in a format of a lookup table. FIG. 8 illustrates an example in which a peak boost time to which a compensation time is applied is stored in a format of a lookup table.

Referring to FIG. 7, it can be known that the discharge time to which the compensation time is applied is defined according to the sum of the total energy of the pixels of the scan line. In this case, the data control logic unit 101 can detect the discharge time by searching for the total energy corresponding to the sum calculated by the data summation unit 110.

For example, when the total energy corresponding to the sum obtained from the data summation unit 110 is 12, a discharge time corresponding to an index of 12 stored in the lookup table, which is 9 time units, can be detected.

In addition, referring to FIG. 8, it can be known that the peak boost time to which the compensation time is applied is defined according to the sum of the total energies of the pixels of the scan line. Accordingly, in this case, the data control logic unit 101 can detect the peak boost time by searching for the energy corresponding to the sum calculated by the data summation unit 110.

For example, when the total energy corresponding to the sum obtained from the data summation unit 110 is 12, a discharge time corresponding to an index of 12 stored in the lookup table, which is 11 time units, can be detected. Accordingly, it is possible to control the compensation for channel interference by using the compensated driving current without additional operations.

Like this, when the data control signal capable of controlling the discharge period, the peak boost period, and the data period is transmitted to the data driving circuit DC by the data control logic unit 101, the display operation in which the channel interference is removed can be achieved by sequentially connecting the discharge driving circuit 71, the peak boost driving circuit 72, and the data period driving circuit 73 to the data line D depending on the control time through the switching operation.

The contents of the lookup table are predetermined or can be changed according to characteristics of the pixels by externally downloading contents from an outside (for example, a main control system) in an operation of initially setting the driving circuit.

As described above, in the present invention, it is possible to solve problems such as an increase of the circuit size caused by the existing compensation operation for the channel interference by controlling the discharge period or peak boost period with respect to each scan line and compensating for the channel interference phenomenon. In addition, since it is possible to compensate for the channel interference through a method of using software without separate hardware, the method is advantageous in an economical aspect.

While the present invention has been particularly shown and described with reference to exemplary embodiments thereof, it will be understood by those skilled in the art that various changes in form and details may be made therein without departing from the spirit and scope of the present invention as defined by the appended claims.

Particularly, although the method of controlling the discharge time or peak boost time through the calculated compensation time is described in the aforementioned embodiment, the discharge time and the peak boost time may be concurrently controlled for a more accurate control. Accordingly, various changes of the exemplary embodiments may be made therein without departing from the spirit and scope of the invention.

What is claimed is:

1. A method of compensating for channel interference of a display apparatus, the method comprising:
receiving pixel data of a scan line selected from an external screen memory;
summing up the received pixel data and detecting a compensation time for compensating for channel interference which occurs in the selected scan line by using the sum of the pixel data; and
adjusting at least one of a discharge time and a peak boost time of a driving current that is output to each data line according to the detected compensation time,
wherein in the detecting of the compensation time, a lookup table, in which a compensation time depending on the sum of the pixel data of the scan line is stored, is searched by using the sum of the pixel data.

2. A method of compensating for channel interference of a display apparatus, the method comprising:
receiving pixel data of a scan line selected from an external screen memory;
summing up the received pixel data;
calculating a compensation energy, which compensates for a loss caused by channel interference that occurs in the selected scan line, by using the sum of the pixel data;
detecting the compensation time corresponding to the calculated compensation energy; and
adjusting at least one of a discharge time and a peak boost time of a driving current that is output to each data line according to the detected compensation time.

3. The method of claim 2, wherein the calculating of the compensation time comprises:
detecting an ideal energy value, which drives the pixels connected to the selected scan line in a luminance corresponding to the sum of the pixel data, and a practically measured energy value, which drive the pixels connected to the selected scan line in the luminance corresponding to the sum of the pixel data; and
subtracting the detected measured energy value from the detected ideal energy value.

4. The method of claim 2, wherein in the adjusting of at least one of a discharge time and a peak boost time of a driving current, the adjusted discharge time of the driving current corresponds to a time obtained by subtracting the compensation time from a predetermined reference discharge time.

5. The method of claim 2, wherein in the adjusting of at least one of a discharge time and a peak boost time of a driving current, the adjusted peak boost time corresponds to a time obtained by adding the compensation time to a predetermined reference discharge time.

6. A device for controlling driving of a data signal, which controls a driving current supplied to a data line of a display panel, the device comprising:
a data summation unit which receives pixel data to be displayed on a selected scan line of the display panel and sums up the pixel data;
a lookup table in which compensation time information corresponding to the sum of the pixel data of the scan line of the display panel is stored; and
a data control logic unit which detects a compensation time corresponding to the sum obtained from the data summation unit by searching the lookup table and adjusts at least one of the discharge period and the peak boost period of the driving current supplied to the data line in consideration of the detected compensation time.

7. The device of claim 6, wherein the data summation unit receives pixel data to be displayed on the scan line from a screen memory of the display panel.

8. A device for controlling driving of a data signal, which controls a driving current supplied to a data line of a display panel, the device comprising:
a data summation unit which receives pixel data to be displayed on a selected scan line of the display panel and sums up the pixel data;
a compensation time providing unit which provides compensation time information corresponding to the sum of the pixel data of the scan line of the display panel; and
a control logic unit which receives a compensation time corresponding to the sum obtained from the data summation unit from the compensation time providing unit and adjusts at least one of the discharge period and the peak boost period of the driving current supplied to the data line on the basis of the detected compensation time,
wherein the compensation time providing unit calculates a compensation energy capable of compensating for a loss caused by channel interference which occurs in the scan line and provides the compensation time corresponding to the calculated compensation energy.

9. The device of claim 8, wherein the data summation unit receives pixel data to be displayed on the scan line from a screen memory of the display panel.

10. The device of claim 8, wherein the compensation energy is calculated by detecting an ideal energy value, which drives the pixels connected to a predetermined scan line in predetermined luminance, and a practically measured energy value, which can drive the pixels connected to the predetermined scan line in the predetermined luminance, and subtracting the detected measured energy value from the detected ideal energy value.

11. The device of claim 8, wherein the data control logic unit adjusts the discharge period so that the discharge period is a time obtained by subtracting the compensation time from a predetermined discharge time.

12. The device of claim 8, wherein the data control logic unit adjusts the peak boost period so that the peak boost period is a time obtained by adding the compensation time to a predetermined peak boost time.
